(19) United States
(12) Patent Application Publication
(10) Pub. No.: US 2007/0128082 A1
(43) Pub. Date: Jun. 7, 2007

(54) Microflow coverage ratio control device

(75) Inventors: Hung-Jen Yang, Hsinchu Hsien (TW); Nan-Kuang Yao, Hsinchu Hsien (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu Hsien (TW)

(21) Appl. No.: 11/476,070

(22) Filed: Jun. 28, 2006

(30) Foreign Application Priority Data
Dec. 1, 2005 (TW) 94142256

(51) Int. Cl. B01L 3/00

(52) U.S. Cl. 422/100

(57) ABSTRACT

The present invention provides a microflow coverage ratio control device, which comprises two reservoirs, at least one communication channel, a flow driver and two external tubes. The present invention utilizes liquid-level gravities of fluids in the two reservoirs to drive the fluids simultaneously flowing into a reaction chamber to form different fluid coverage ratios in the reaction chamber. The present invention employs the flow driver associated with the communication channel to change the liquid levels of the fluids in the two reservoirs, thereby changing the fluid coverage ratios in the reaction chamber. According to the potential energy conservation, the fluid pressure of the reaction chamber is kept constant during the change of the fluid coverage ratios. The interference of the reaction chamber is eliminated.

### BACKGROUND OF THE INVENTION

1. Field of the Invention

The present invention relates to a microflow coverage ratio control device, and more particularly to a microflow coverage ratio control device capable of maintaining a constant fluid pressure in a reaction chamber during the change of the fluid coverage ratios inside the reaction chamber.

2. Description of the Related Art

It provides many advantages such as reducing artificial experimental error, enhancing system stability, reducing energy consumption and sample amount, as well as saving manpower and time to perform a biomedicine test or analysis using microfluidic chips. However, the miniaturization of elements make the target under study more sensitive to variations of many parameters regarding the experimental zone, such as change of pressure, temperature or humidity, change of medicine concentration, and even change of medicine flow, etc. The changes of these parameters may cause experimental interferences and errors, thereby resulting in misjudging the experiment. Referring to FIG. 1, Doring et al. discloses a miniaturized fluid-guiding system in the article entitled “Micromachined Thermoelectrically Driven Cantilever Structures for Fluid Jet Deflection”, published in Proc. IEEE Micro Electro Mechanical System Workshop, 1992. The system uses electrical signals to control the direction of the fluid and is provided with active elements such as microvalves for easy use. However, the system requires additional active valves, increasing difficulty of manufacturing and cost. Referring to FIG. 2 and FIG. 3, Guo Bin, Li et al. discloses control methods for the direction of the fluid in the article entitled “Micromachined Prefocused 1×N Flow Switches for Continuous Sample Injection” published in J. Micromechanics and Microengineering, 11, pp 567, 2001 and in the article entitled “Micromachined Prefocused N×M Flow Switches for Continuous Sample Injection” published in J. Micromechanics and Microengineering, 11, pp 654, 2001. These methods have the advantage that the direction of the fluid can be precisely controlled by hydrodynamics without any valves. In one article published by Otsuka et al. in μ-TAS, 1, 30, 2004, a cell collector adopting the principle of flow speed change is disclosed. The collector can collect two kinds of cells and does not need additional valves. However, the disadvantage is pollution.

In the traditional biochemistry domain, one biochemical experiment is performed with only one operating variable at one time. Even if various experiments are carried out at one time, they still have different operating variables. It is difficult to keep external environment under constant and same conditions, such as maintaining constant temperature, constant pressure, fixed concentration of nutrient waste in a culture medium, etc. In addition, it takes a large amount of manpower, material and cost to perform an experiment. As such, various experiments can not be carried out at one time. A system platform that can perform more than two experiments at one time and keep the same biochemical environment for each experiment so as to verify effectiveness of a medicine is strongly needed and would become prominent in the future.

### SUMMARY OF THE INVENTION

It is a primary objective of the present invention to provide a microflow coverage ratio control device, by which two fluids can steadily change their flow coverage ratio in a reaction zone so as to keep a constant fluid pressure inside the reaction zone and thus eliminate the interference on the target cells caused by the disturbance of the fluid pressure.

It is another objective of the present invention to provide a microflow coverage ratio control device, in which a precise microflow coverage ratio control can be achieved by a general actuator and the flow coverage ratios of fluids in a reaction zone can be precisely controlled by programmably controlling the movement of the fluids in forward and backward directions in micro-channels communicated with reservoirs containing the fluids.

It is a further objective of the present invention to provide a microflow coverage ratio control device used for cell culture, cell-to-medicine test, or biochemical test, etc.

According to the above objectives, the present invention provides a microflow coverage ratio control device, which comprises two reservoirs, at least one communication channel, a flow driver and two external tubes. The two reservoirs respectively contain a first fluid and a second fluid. The at least one communication channel is communicated between the two reservoirs, and the length thereof is long enough to prevent the first fluid and the second fluid from mixing. The flow driver is combined with the at least one communication channel to control flow directions of the first fluid and the second fluid in the at least one communication channel such that the liquid-level difference between the two reservoirs can be controlled. The two external tubes are respectively connected to the two reservoirs. As such, the liquid-level gravities in the two reservoirs can drive the first fluid and the second fluid simultaneously flowing into a reaction zone via the two external tubes so as to control the coverage ratio of the first fluid different from that of the second fluid in the reaction zone.

The present invention adopts the characteristic of the micro-channels and energy-level concept to make it possible that carrying out more than two experiments in a reaction chamber at one time and eliminating the interferences to the reaction chamber causing by uncontrolled factors. The present system is a simple device with low cost, and having a wide working-flow-rate range. The present system can be applied to any fields adopting micro-fluids, and has commercial potential.

### BRIEF DESCRIPTION OF THE DRAWINGS

FIG. 1 is a schematically structural view of a traditional miniaturized fluid-guiding system;

FIG. 2 is a schematically structural view of a known micromachined prefocused 1×N flow switches for continuous sample injection;

FIG. 3 is a schematically structural view of a known micromachined prefocused M×N flow switches for continuous sample injection;

FIG. 4 is a schematically structural view of a known cell collector using the principle of flow speed change;

FIG. 5 is a schematically structural view of one preferred embodiment of the present microflow coverage ratio control device combined with a biological reactor;

FIGS. 6A and 6B are partial views of the present microflow coverage ratio control devices respectively with two different flow directions of fluids; and

FIG. 7 illustrates liquid-levels change of the fluids under the potential energy conservation.

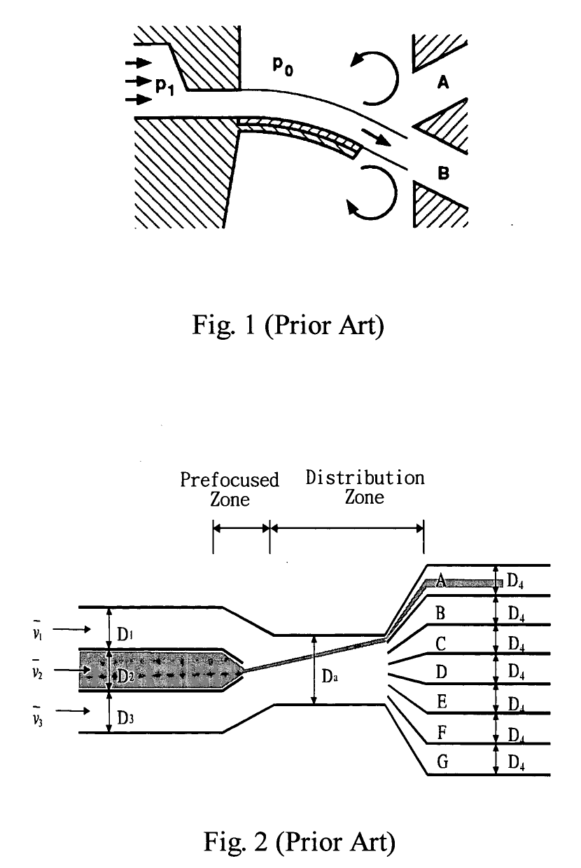

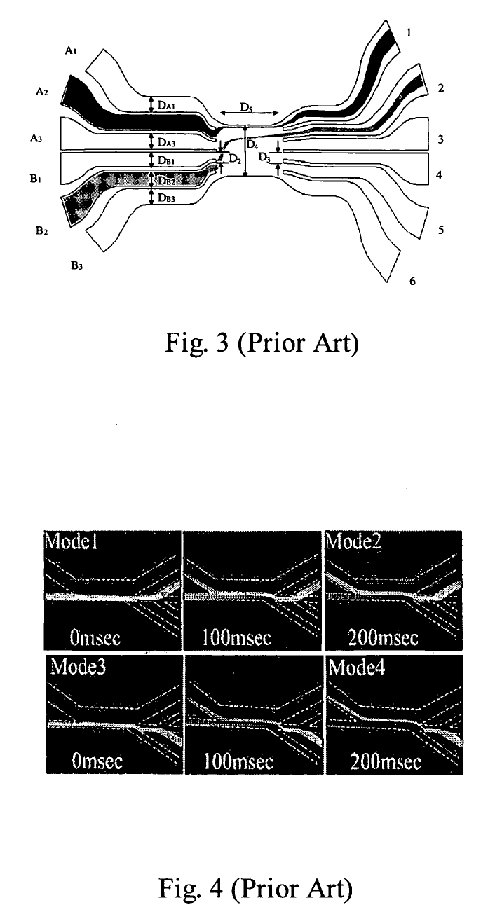

### DETAILED DESCRIPTION OF THE PREFERRED EMBODIMENTS

The present invention provides a microflow coverage ratio control device, which makes two fluids steadily change their flow coverage ratios in a reaction zone. The present device can achieve a high precise microflow coverage ratio control by a general actuator, and the coverage ratios of the fluids in the reaction zone can be precisely controlled by programmably controlling movements of the fluids in forward and backward directions in micro-channels communicated with reservoirs containing the fluids. The present microflow coverage ratio control device comprises at least two reservoirs communicated with each other by at least one communication channel. The communication channel will work in conjunction with a flow driver. Each of the reservoirs is further provided with an external tube for communicating with a biological reactor. The present invention uses a flow driver to control the flow directions of the fluids in the communication channel so as to control the liquid-level differences between the reservoirs. As a result, the liquid-level gravities in the reservoirs can drive the fluids simultaneously flowing into the biological reactor via the external tubes. Since the flow resistance of the fluids is increased as the length of the external tubes is increased, a long-length micro-channel is adopted to increase flow resistance of the fluids and reduce pressure disturbance generated by the flow driver. Moreover, due to the characteristic of micro-fluids, the fluids flowing in the long-length micro-channel are not easily mixed to each other. As such, the fluids flowing in the micro-channel can maintain their relative position relationship and would not get mixed to each other. Additionally, the present invention adopts the flow driver, for example a gravitational pump, associated with the communication channel to change the liquid levels of the fluids in the reservoirs so as to change the fluid coverage ratios of the fluids in the external biological reactor. The total potential energy of the reservoirs is kept constant during the change of the liquid levels in the reservoirs, and therefore the fluid pressure of the biological reactor is kept balanced during the change of the liquid levels in the reservoirs. Consequently, the living cells in the biological reactor will only experience different kinds of fluids and will not be affected by any change of external pressure during the change of the fluid coverage ratios. A real effect of reagents on biological fluids in the biological reactor can be exactly reflected.

The microflow coverage ratio control device of the present invention will be described in detail by the following embodiments with reference to the accompanying figures.

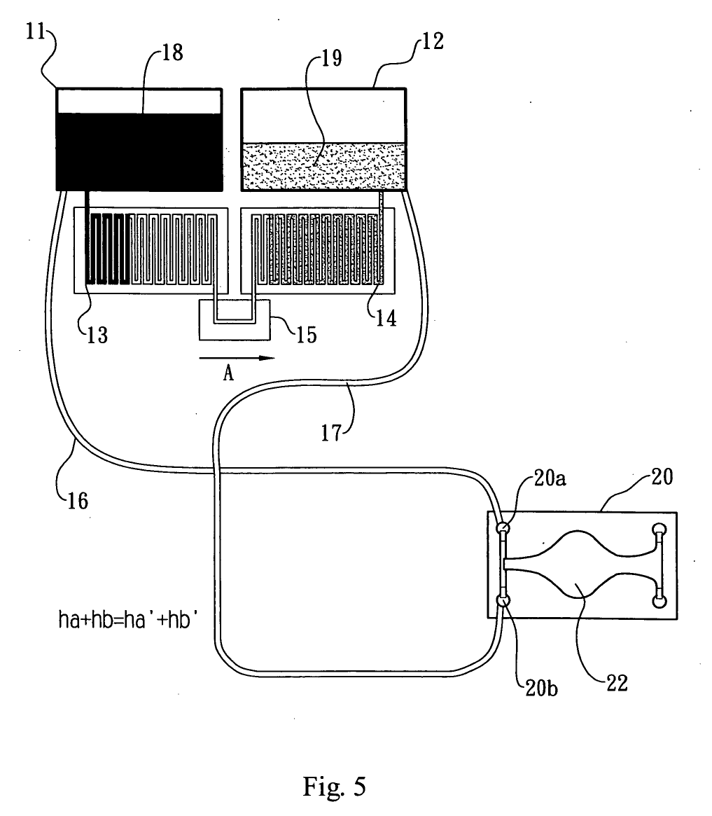

FIG. 5 is a schematically structural view of a preferred embodiment of the present microflow coverage ratio control device combined with a biological reactor. In the preferred embodiment, the microflow coverage ratio control device of the present invention comprises two reservoirs 11 and 12, at least one communication channel 13 and 14, a flow driver 15 and two external tubes 16 and 17. The two reservoirs 11 and 12 respectively contain a first fluid 18 and a second fluid 19. The two reservoirs 11 and 12 communicate with each other via the communication channel 13 and 14. The communication channel 13 and 14 can have a multi-bending micro-channel structure formed in a PMMA substrate by precise milling machining.

The flow driver 15 is combined with the communication channel 13 and 14 to control the flow directions, such as indicated by the arrow A, of the first fluid 18 and the second fluid 19 in the communication channel 13 and 14. The liquid-level differences between the first fluid 18 and the second fluid 19 in the two reservoirs 11 and 12 can hence be controlled. The flow rates of the first fluid 18 and the second fluid 19 can also be controlled by the liquid-level gravities of the first fluid 18 and the second fluid 19 in the reservoirs 11 and 12. Furthermore, the communication channel 13 and 14 has a channel length long enough to prevent the first fluid 18 and the second fluid 19 from mixing in the communication channel 13 and 14. Specifically, the present invention adopts the characteristic of the micro-channels to effectively separate different solutions in the micro-channel and thus keep their flow sequence to prevent the different solutions from mixing to each other. Moreover, a long-length micro-channel can provide an appropriate flow resistance. The pressure disturbance generated by the flow driver can be mitigated by the pressure-buffering function provided by a bending channel. The entrances of the external tubes 16 and 17 are respectively connected with the reservoirs 11 and 12, and the outlets of the external tubes 16 and 17 are respectively connected with a corresponding entrance 20a and 20b of the biological reactor 20. The present invention utilizes the liquid-level gravities of the first fluid 18 and the second fluid 19 in the reservoirs 11 and 12 to drive the first fluid 18 and the second fluid 19 simultaneously flowing into the biological reactor 20 via the two external tubes 16 and 17. Additionally, due to the different liquid-level gravities of the first fluid 18 and the second fluid 19, the flow rates of the first fluid 18 and the second fluid 19 in the external tubes 16 and 17 are also different such that when the first fluid 18 and the second fluid 19 flow into the biological reactor 20, the first fluid 18 and the second fluid 19 form different coverage ratios in the reaction zone 22. The biological reactor 20 can be a microfluidic chip, and cell culture can be carried out thereon to facilitate the cell-to-medicine test or biochemical test.

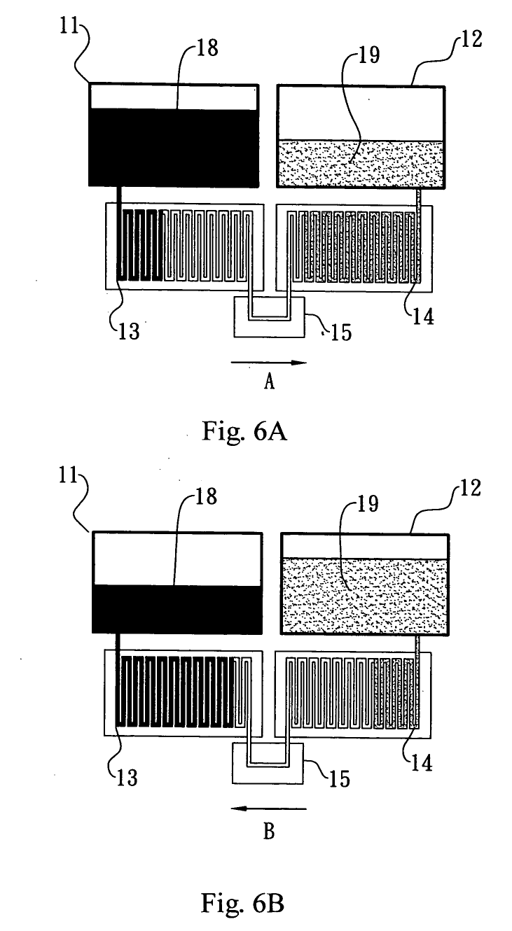

Referring to FIG. 6A and FIG. 6B, the present invention adopts the flow driver 15, such as a gravitational pump, to control the movements of the first fluid 18 and the second fluid 19 in the communication channel 13 and 14 toward the forward direction or backward direction, such as indicated by the arrow A and B, to change the liquid levels of the first fluid 18 and the second fluid 19 in the reservoirs 11 and 12. As a result, the flow rates of the first fluid 18 and the second fluid 19 in the external tubes 16 and 17 are changed, and thus the fluid coverage ratios of the first fluid 18 and the second fluid 19 in the reaction zone 22 are also changed.

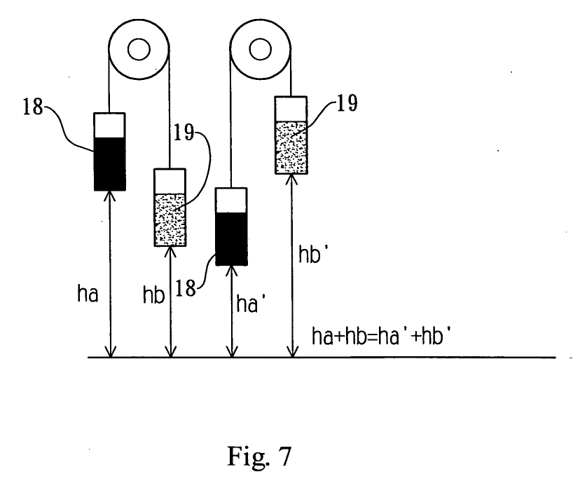

Referring to FIG. 5 and FIG. 7 again, according to the present invention, the total potential energy of the first fluid 18 and the second fluid 19 in the reservoirs 11 and 12 is kept constant during the change of the liquid levels (ha+hb=ha′+hb′), i.e. the liquid levels of the first fluid 18 and the second fluid 19 are controlled to rise or fall simultaneously such that the total fluid pressure of the biological reactor 20 is kept constant during the change of the liquid levels. Consequently, the cells in the biological reactor 20 will not be affected due to any change of external parameters. The interference on the biochemical experiment is adequately reduced. Various experiments can be carried out on the target in the biological reactor 20 and sufficiently reflect the corresponding parameters. Additionally, the fluids can maintain their sequences during flowing and will not be mixed to each other. The fluids can have smooth coverage areas in the reaction zone. The rotational speed and direction of the flow driver 15 can be controlled by a computer to programmably control the coverage ratios of different fluids in the reaction zone. According to the design of the present invention, the disturbance generated by the flow driver 15 is eliminated. The present device can have a high precise microflow coverage ratio control by using a general actuator, e.g. a peristaltic pump.

The present invention utilizes the characteristics of microfluidic chips to provide a steady dynamic fluid-guiding function for a micro-structure. The microflow coverage ratio control device of the present invention provides the following advantages: the fluid can have a steady flow rate, a high precise microflow coverage ratio control can be obtained by using a general actuator, and the precise coverage ratios of the fluids in the reaction zone can be obtained by programmably controlling the movements of the fluids in the micro-channel toward the forward direction or backward direction.

In the biomedicine domain, an experiment contrast set is needed when carrying out a cell-to-medicine test or developing a new medicine. It had better only have controlled parameters affect the test result and there is no any other interference happen. The microflow coverage ratio control device of the present invention meets these requirements. The present device is a simple system with low cost, which is suitable for mass production and easy to carry. The present invention has a great usability and commercial opportunity, which can be widely used in the biomedicine domain.

It is to be understood that the foregoing general description is exemplary and explanatory only and is not restrictive of the invention as claimed. Various alterations and modifications made to the embodiments without departing from the spirit of the present invention should still remain within the scope of the following claims.

What is claimed is:

1. A microflow coverage ratio control device, comprising:
two reservoirs respectively containing a first fluid and a second fluid;
at least one communication channel communicated between said two reservoirs and the length of said communication channel being long enough to prevent said first fluid and said second fluid from mixing;
a flow driver combined with said at least one communication channel to control flow directions of said first fluid and said second fluid in said at least one communication channel; and
two external tubes respectively connected with one of said two reservoirs such that the liquid-level gravities in said two reservoirs drive said first fluid and said second fluid simultaneously flowing into a reaction chamber via said two external tubes.

2. The microflow coverage ratio control device as claimed in claim 1, wherein said at least one communication channel is a -bending channel.

3. The microflow coverage ratio control device as claimed in claim 2, wherein said at least one communication channel is a multi-bending channel.

4. The microflow coverage ratio control device as claimed in claim 1, wherein said flow driver controls the flow directions of said first fluid and said second fluid in said at least one communication channel so as to change liquid levels in said two reservoirs.

5. The microflow coverage ratio control device as claimed in claim 4, wherein the liquid-levels in said two reservoirs are changed to change flow coverage ratios of said first fluid and said second fluid in said reaction chamber.

6. The microflow coverage ratio control device as claimed in claim 1, wherein said flow driver controls the liquid-levels of said first fluid and said second fluid to rise or fall simultaneously such that the pressure of said reaction chamber is balanced.

7. The microflow coverage ratio control device as claimed in claim 1, wherein said reaction chamber is a biological reaction chamber.

8. The microflow coverage ratio control device as claimed in claim 1, wherein said reaction chamber is a microfluidic chip.
